(19) United States
(12) Patent Application Publication
(10) Pub. No.: US 2018/0330555 A1
(43) Pub. Date: Nov. 15, 2018

(54) QUICK PARKING SYSTEMS AND METHODS

(71) Applicant: Walmart Apollo, LLC, Bentonville, AR (US)

(72) Inventors: Steven Lewis, Bentonville, AR (US); Nicholaus A. Jones, Fayetteville, AR (US); Matthew Biermann, Fayetteville, AR (US)

(21) Appl. No.: 15/976,433

(22) Filed: May 10, 2018

Related U.S. Application Data
(60) Provisional application No. 62/505,198, filed on May 12, 2017.

(51) Int. Cl. G07B 15/02; G06Q 10/02; G06Q 20/18; H04W 4/029

(52) U.S. Cl. CPC G07B 15/02; G06Q 10/02; G06Q 20/20; H04W 4/029; G06Q 20/18

(57) ABSTRACT

Embodiments relate to parking management systems and methods in a retail environment. The parking management system can include a plurality of reserved vehicle parking places, a parking registration kiosk, at least one in-store sensor, and an analytics engine. The plurality of reserved vehicle parking places can be located proximate to an entrance of the retail environment. The parking registration kiosk can include a user interface configured to enable a customer-user to register one of the plurality of reserved vehicle parking places for parking use for a limited amount of time, and issue a token configured to display a countdown timer, displaying the permitted parking time remaining. The at least one in-store sensor can be arranged the sensed the location of the customer-user within the retail environment. The analytics engine can be configured to manage the countdown timer based on the sensed location of the customer-user.

### RELATED APPLICATION

The present application claims the benefit of U.S. Provisional Application No. 62/505,198 filed May 12, 2017, which is hereby incorporated by reference herein in its entirety.

### TECHNICAL FIELD

Embodiments relate generally to motor vehicle parking control and management. More particularly, embodiments relate to systems and methods for providing and managing quick-trip, time limited parking spaces in a retail environment.

### BACKGROUND

Many large retail stores, for example big-box stores or supercenter-type stores, have large parking lots that may cover up to an acre or more of space nearby the store. As the parking lot fills up with parked vehicles, customers who wish to shop at the retail store may be required to park some distance away from the entrance of the retail store. In some cases, customers may be required to park more than 100 yards away from the entrance of the retail store. Walking and carrying purchased goods between the entrance and the customer's parked vehicle can add a significant amount of time to the shopping experience.

Customers who wish to make a quick stop at a retail store, for example to purchase just a few items, may be discouraged from doing so because of the amount of time that is added to the shopping experience as a result of the transit time between their parked vehicle and the entrance to the retail store. In some cases, the additional transit time may be sufficient to discourage customers from making quick stops at the retail store; even when they routinely shop at the retail store and readily know where the products that they desire are displayed within the retail store.

Accordingly, there is a need for more efficient managing of vehicle parking in a manner that makes the parking readily available for customers on a short-term, as-needed basis, while enabling other customers to park without interfering with normal access to the entrance of the retail store.

### SUMMARY

In one embodiment, a parking management system for use in retail environments comprises a plurality of reserved vehicle parking places located proximate an entrance to a retail environment and each comprising at least one parking sensor; a parking registration kiosk comprising a user interface via which a customer-user can register, upon arrival, use of one of the plurality of reserved vehicle parking places for a limited amount of time, the kiosk configured to issue a token to the customer-user, the token comprising a display to display a countdown of the limited amount of time remaining; at least one in-store sensor arranged in the retail environment to sense a presence and a location of the customer-user therein via the token; and an analytics engine communicatively coupled with the at least one parking sensor, the kiosk, the token, the at least one in-store sensor and point-of-sale (POS) system, the analytics engine configured to cause the token to stop the countdown when the at least one in-store sensor senses that the location of the customer-user is proximate the POS system in the retail environment and to resume the countdown when the at least one in-store sensor senses that the location of the customer-user is no longer proximate the POS system, and to confirm that the customer-user has discontinued use of one of the plurality of reserved vehicle parking places by the end of the limited amount of time via data sensed by the at least one parking sensor.

In another embodiment, a method of managing parking in retail environments comprises designating a plurality of reserved vehicle parking places proximate an entrance to a retail environment; accepting registration of use of one of the plurality of reserved vehicle parking places for a limited amount of time by a customer-user by issuing a token to the customer-user; displaying a countdown of the limited amount of time remaining on the token; sensing a presence and a location of the customer-user in the retail environment via the token; causing the token to stop the countdown when the location of the customer-user is proximate a point-of-sale (POS) system in the retail environment and to resume the countdown when the location of the customer-user is no longer proximate the POS system; and confirming that the customer-user has discontinued use of one of the plurality of reserved vehicle parking places by the end of the limited amount of time by sensing a presence or an absence of a vehicle associated with the customer-user in the one of the plurality of reserved vehicle parking places.

The above summary is not intended to describe each illustrated embodiment or every implementation of the subject matter hereof. The figures and detailed description that follow more particularly exemplify various embodiments.

### BRIEF DESCRIPTION OF THE DRAWINGS

Subject matter here of may be more completely understood in consideration of the following detailed description of various embodiments in connection with the accompanying figures.

FIG. 1 is a schematic view depicting a parking management system for use in a retail environment, according to one embodiment of the disclosure.

FIG. 2 is a schematic view depicting a determining of a path taken by a customer-user in a retail environment via the parking management system, according to one embodiment of the disclosure.

FIG. 3 is a flow chart of a method of managing parking in retail environments, according to one embodiment of the disclosure.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION

Embodiments relate to systems and methods for providing and managing quick-trip, time-limited parking spaces in the retail environment, which can aid in minimizing the amount of time required for quick stops, as when compared to parking in conventional locations. In one embodiment, the retail store can provide a limited number of parking spots in proximity to the entrance of the retail store dedicated to customer-users who wish to make a quick-stop (e.g., purchase just a few items). Customer-users who park in the spots can register their parked vehicle and receive a token. For example, in one embodiment, the customer-user can register their parked vehicle at either a kiosk or via a mobile electronic device, such as a cellular telephone. The token, which can be physical or electronic, can be configured to provide a countdown timer indicating the remaining amount of time that the customer-user is permitted to park in the quick-stop parking space. The timer can pause the countdown when the customer-user reaches a Point-of-Sale (POS) system or area to purchase the goods they have selected. To ensure that the customer-user proceeds to their vehicle in a timely manner, the timer can resume the countdown, or another timer can be started after the goods have been purchased. In one embodiment, customer-user's who park their vehicles in the quick-stop parking spaces beyond the permitted parking time can be charged for the additional parking time.

In another embodiment, the present disclosure provides a parking management system for use in retail environments. The parking management system can include a plurality of reserved parking places, a parking registration kiosk, at least one in-store sensor, and an analytics engine. The plurality of reserved vehicle parking places can be located proximate to an entrance of a retail environment. Each of the plurality of reserved parking places can include at least one parking sensor. The parking registration kiosk can include a user interface by which a customer-user, upon arrival, can register for use of one of the plurality of reserved vehicle parking places for a limited amount of time. The parking registration kiosk can additionally be configured to issue a token to the customer-user that includes a display to display a countdown of the limited amount of time remaining. There at least one in-store sensor can be arranged in the retail environment to sense a presence and location of the customer-user therein by way of the token. The analytics engine can be communicatively coupled to the at least one parking sensor, the kiosk, the token, the at least one in-store sensor, and a POS system. The analytics engine can be configured to cause the token to stop the countdown when the at least one in-store sensor senses that the location of the customer-user is proximate to the POS system in the retail environment, resume the countdown when the at least one in-store sensor senses that the location of the customer-user is no longer proximate to the POS system, and confirm that the customer-user has discontinued use of one of the plurality of reserved vehicle parking places by the end of the limited amount of time by way of data sensed by the at least one parking sensor.

In another embodiment, the present disclosure provides a method of managing parking in retail environments, including: designating a plurality of reserved vehicle parking places proximate to an entrance of a retail environment; accepting registration of use of one of the plurality of reserved vehicle parking places for a limited amount of time by a customer-user by issuing a token to the customer-user; displaying a countdown of the limited amount of time remaining on the token; sensing a presence and location of the customer-user in the retail environment via the token; causing the token to stop the countdown when the location of the customer-user is proximate to a POS system in the retail environment and resuming the countdown when the location of the customer-user is no longer proximate to the POS system; and confirming that the customer-user has discontinued use of one of the plurality of reserved vehicle parking places by the end of the limited amount of time by sensing a presence or absence of a vehicle associated with the customer-user and the one of the plurality of reserved vehicle parking places.

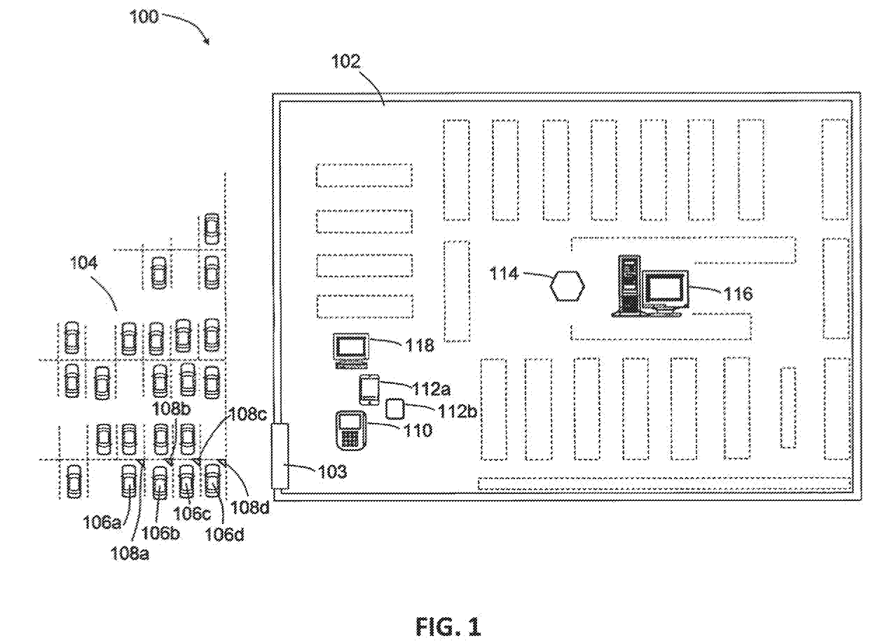

Referring to FIG. 1, a parking management system 100 for use in a retail environment is depicted in accordance with an embodiment of the disclosure. The retail environment can include a retail store 102 and an associated parking lot 104. The parking management system 100 can include a plurality of reserved vehicle parking places 106a-d, a parking registration kiosk 110, at least one in-store sensor 114, and an analytics engine 116.

The plurality of reserved vehicle parking places 106a-d can be located proximate to an entrance 103 of the retail store 102. For example, in one embodiment, the plurality of reserved parking places 106a-d can be a limited number of “front row” parking spots positioned in proximity to the entrance 103 to the retail store 102. In another embodiment, a separate, dedicated quick-stop entrance 103 to the retail store 102 can be associated with the parking management system 100.

As depicted, in one embodiment, there can be four reserved parking places 106a-d; however, a greater or lesser number of reserved parking places are also contemplated. Each of the reserved parking places 106a-d can include at least one parking sensor 108a-d. In one embodiment, each parking sensor 108a-d can include an optical sensor, such as a camera, which can be configured to capture license plate or other vehicle identifying information of the vehicle position within the reserved parking place 106a. Additionally, the parking sensors 108a-d can be configured to determine when no vehicle is present in the reserved parking place (e.g., the reserved parking place 106a is empty).

The parking registration kiosk 110 can be positioned proximal to the plurality of reserved parking places 106a-d, within the retail store 102, or located between the plurality of reserved parking places 106a-d and the retail store 102. In some embodiments, multiple parking registration kiosks 110 can be positioned at different locations, such as one proximal to the plurality of reserved parking places 106a-d and one within retail store 102. In one embodiment, the parking registration kiosk 110 can be a digital kiosk loaded on or accessed by a mobile electronic device, such as a customer-user's smartphone. In one embodiment, the parking registration kiosk 110 can include a user interface via which a customer-user can register use of one of the plurality of reserved vehicle parking places 106a-d. Upon registration, the parking registration kiosk 110 can issue a token 112 to the user-customer.

In one embodiment, the token 112a can be an electronic token on a mobile electronic device or electronic device belonging to the customer-user. For example, a computing application associated with the parking management system can be installed on the customer-user's mobile electronic device to provide the user interface and facilitate receipt of the token 112a. In another embodiment, the token 112b can be a physical token dispensed or issued by the kiosk 110.

In one embodiment, the permitted amount of parking time can represent a predefined period of time, for example, 5, 8, 10, or 15 minutes. Other durations of predefined periods of time are also contemplated. In one embodiment, the customer-user can select from a plurality of available predefined times (e.g., 5, 8, 10, or 15 minutes) and can be incentivized with, for example, coupons, reward points, or other rewards for choosing the least amount of parking time, thereby encouraging turnover of the plurality of reserved parking places 106a-d for use by others. For example, in one embodiment, customer-user's can earn additional time for quick-trip parking privileges by making purchases or through a loyalty program at the retail store 102 or a related retail store chain. In one embodiment, complimentary quick stop parking can be provided and/or automatic adjustments to the permitted time can be made for certain customer-users (e.g., expectant mothers, military members, and veterans).

Once the customer-user has registered their vehicle at the parking registration kiosk 110, the token 112 can display a countdown of the remaining permitted amount of time to park within the reserved vehicle parking place 106a-d. In one embodiment, the time can be shown on a display of the customer-user's mobile electronic device 112a. In another embodiment, the physical token 112b can include a display with a visible timer. In another embodiment, a countdown timer can be provided proximal to each parking spot, for example by a parking meter or display device. Multiple displays and countdown timers can be used for each reserved vehicle parking place 106a-d. In one embodiment, a visual, audible, and/or haptic alert can notify the customer when a predefined period of time for permitted parking remains.

The at least one in-store sensor 114 can be positioned within the retail store 102, and can be configured to sense a presence and location of the customer-user therein via the token 112. For example, in one embodiment, each of the tokens 112b can include an RFID tag, rechargeable Wi-Fi emitter, or other detectable technology, such that the at least one in-store sensor 114 can determine a location of each token 112b. In another embodiment, the at least one in-store sensor 114 can be configured to receive location data, such as GPS positional information, from the token 112a. In one embodiment, the positional information can include a timestamp or temporal element, thereby enabling the construction of a path taken by the customer-user while in the retail store 102.

The analytics engine 116 can be in electrical communication with the at least one parking sensor 108a-d, the kiosk 110, the token 112, the at least one in-store sensor 114, and a POS system 118. In one embodiment, the electrical communication can be a direct, wired connection, a radio or wireless connection, or a combination thereof In one embodiment, a dedicated quick-stop POS system 118 can be associated with the parking management system 100.

In one embodiment, the analytics engine 116 can be configured to pause or suspend the countdown timer when the customer-user approaches the POS system 118 to pay for the items they have selected. Accordingly, the time that the customer-user spends waiting in line to pay for the selected items does not count against the customer-user's permitted parking time. In one embodiment, suspension of the countdown timer can be manually performed by the customer-user upon reaching the POS system 118. Once the customer-user is detected as leaving the POS system 118, the countdown timer can resume the countdown timer, or a different countdown timer can be started.

In some embodiments, the parking registration kiosk 110 can be used to check the customer-user out of the reserved parking place 106a-d, and the physical token 112b can be returned. In other embodiments, the parking sensors 108a-d can be employed to detect when the customer-user's vehicle departs from the reserved parking place 106a-d. Information sensed by the parking sensors 108a-d (e.g., total parking time) can be collected by the analytics engine 116 for further processing.

In one embodiment, the customer-user can be required to input payment information prior to using the parking management system 100. For example, the user interface of the parking registration kiosk 110 can be configured to accept payment information, which can include credit card information or earned credit based on purchases, activities or incentives provided to the customer-user. In one embodiment, the parking management system 100 can be configured to cause the customer-user to be charged via the payment information if the analytics engine 116 determines that the customer-user has not discontinued use of one of the plurality of reserved vehicle parking places 106a-d by the end of the limited amount of time via data sensed by the at least one parking sensor 108a-d. In one embodiment, the charge rates can vary based on the sale amount, historical use, determined customer-user loyalty, or other information stored by the analytics engine 116. Other disincentives for overstaying parking time can also be used.

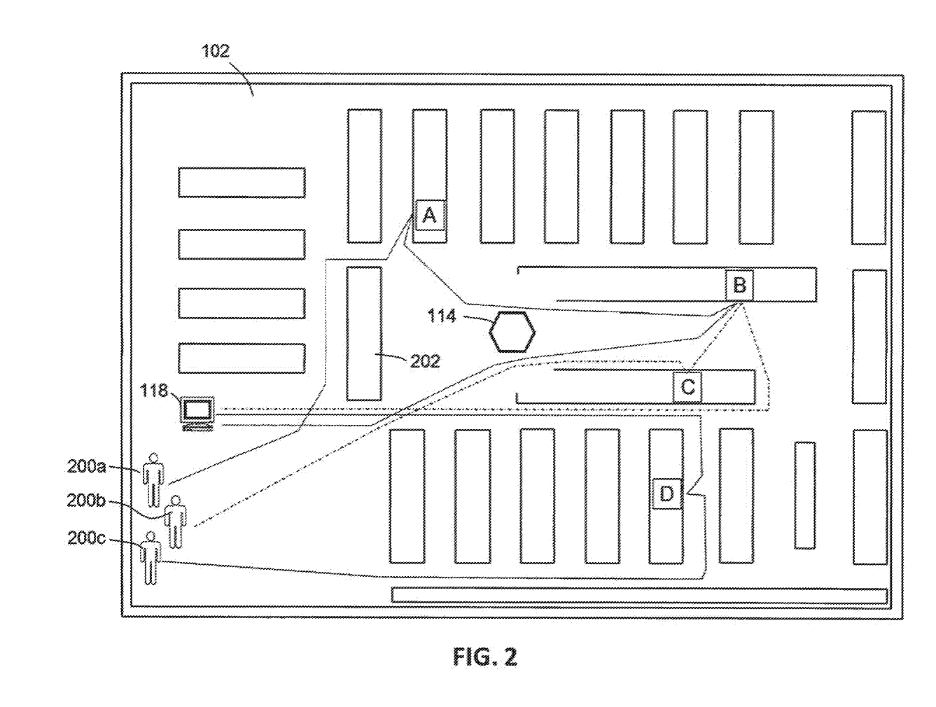

Referring to FIG. 2, in one embodiment, the analytics engine 116 can be configured to determine a path taken by customer-users 200a-c within the retail store 102 via the at least one in-store sensor 114 and the token 112 and/or information from the POS system 118. For example, as depicted, the analytics engine 116 can be used to determine that a first customer-user 200a purchases products A and B, a second customer-user 200a purchases products B and C, and a third customer-user 200c purchases product D. Thereafter, information gathered by the analytics engine 116 can be utilized to suggest at least one alteration to a layout of the retail store 102 for a change in location of a product within the retail store 102 based on purchase data provided by the POS system 118 and/or aggregated paths of a plurality of customer-users 200a-c. In one embodiment, the analytics engine 116 can be configured to determine an optimized layout or location of products based on products frequently purchased within the retail store 102 by customer-users utilizing the parking management system 100, for example by suggesting that products B and C be moved to shelf or area 202. In one embodiment, the analytics engine 116 can be configured to set or adjust the predefined periods of parking time based on customer-user purchase data received from the POS system 118.

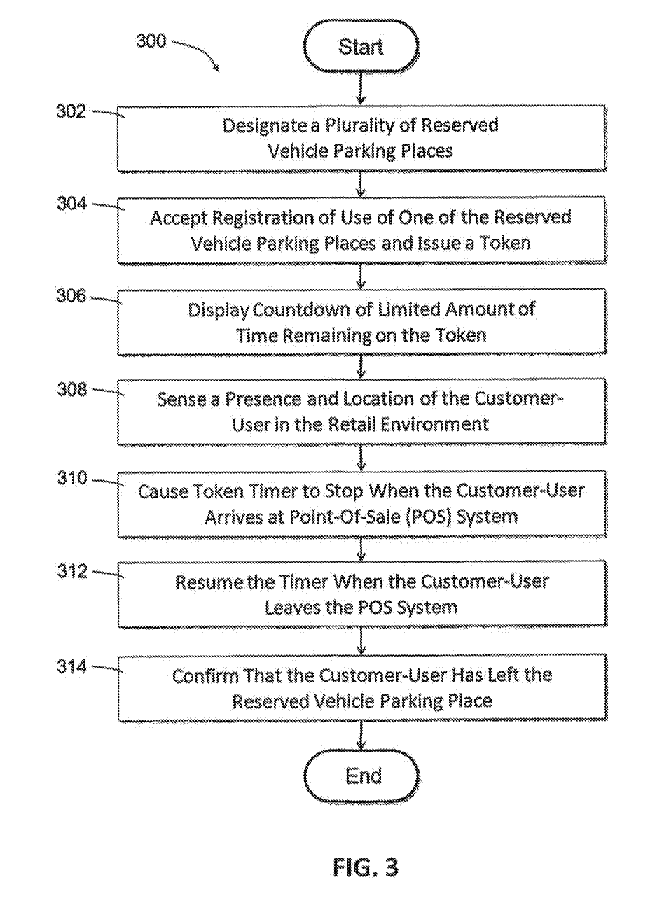

Referring to FIG. 3, a flow chart of a method of managing parking in a retail environment 300 is depicted in accordance with an embodiment of the disclosure. At 302, a plurality of reserved vehicle parking places 106a-d can be designated proximate to an entrance 103 of a retail store 102. At 304, registration of use of one of the plurality of reserved parking places 106a for a limited amount of time by a customer-user can be accepted, and a token 112 can be issued to the customer-user. At 306, a countdown of the limited amount of time can be displayed on the token 112. At 308, a presence and location of the customer-user and the retail store 102 can be sensed via the token 112. At 310, the countdown can be stopped when the customer-user and token 112 are positioned proximate to the POS system 118 within the retail store 102. At 312, the countdown can be resumed when the location of the customer-user and token 112 are no longer positioned proximate to the POS system 118. At 314, it can be confirmed that the user customer has discontinued use of one of the plurality of reserved parking places 106a by the end of the limited amount of time, by sensing a presence or absence of a vehicle associated with the customer-user and the one of the plurality of reserved parking places 106a-d.

In one embodiment, the method can further comprise accepting a return of the token 112 from the customer-user after use. In one embodiment, the method 300 can further comprise accepting payment information from a customer-user, and causing the customer-user to be charged via the payment information if the parking sensor 108a senses the presence of a vehicle associated with the customer-user and the one of the plurality of reserved parking places after the end of the limited amount of time.

In one embodiment, the method 300 can further comprise earning credits by the customer-user for use with the parking management system 100, wherein the earned credits can be based on purchases and/or activities of the customer. In one embodiment, the method 300 can further comprise setting or adjusting the limited amount of time based on customer-user purchase data provided by the POS system 118.

It should be understood that the individual activities used in the methods of the present teachings may be performed in any order and/or simultaneously, as long as the teaching remains operable. Additionally, in some embodiments one or more of the activities can be omitted and/or additional activities can be included in the method. Furthermore, it should be understood that the apparatus and methods of the present teachings can include any number, or all, of the described embodiments, as long as the teaching remains operable.

Various embodiments of systems, devices, and methods have been described herein. These embodiments are given only by way of example and are not intended to limit the scope of the invention. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the invention.

Persons of ordinary skill in the relevant arts will recognize that the subject matter hereof may comprise fewer features than illustrated in any of the individual embodiments described above. The embodiments described herein are not meant to be an exhaustive presentation of the ways in which the various features of the subject matter herein may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims for the present invention, it is expressly intended that the provisions of Section 112, sixth paragraph of 35 U.S.C. are not to be invoked unless the specific terms “means for” or “step for” are recited in a claim.

1. A parking management system for use in retail environments comprising:
a plurality of reserved vehicle parking places located proximate an entrance to a retail environment and each comprising at least one parking sensor;
a parking registration kiosk comprising a user interface via which a customer-user can register, upon arrival, use of one of the plurality of reserved vehicle parking places for a limited amount of time, the kiosk configured to issue a token to the customer-user, the token comprising a display to display a countdown of the limited amount of time remaining;
at least one in-store sensor arranged in the retail environment to sense a presence and a location of the customer-user therein via the token; and
an analytics engine communicatively coupled with the at least one parking sensor, the kiosk, the token, the at least one in-store sensor and point-of-sale (POS) system, the analytics engine configured to cause the token to stop the countdown when the at least one in-store sensor senses that the location of the customer-user is proximate the POS system in the retail environment and to resume the countdown when the at least one in-store sensor senses that the location of the customer-user is no longer proximate the POS system, and to confirm that the customer-user has discontinued use of one of the plurality of reserved vehicle parking places by the end of the limited amount of time via data sensed by the at least one parking sensor.

2. The system of claim 1, wherein the kiosk is located proximate the plurality of reserved vehicle parking places.

3. The system of claim 1, wherein the kiosk is a digital kiosk, and wherein the token is a digital token that resides on an electronic device.

4. The system of claim 3, wherein the electronic device is a mobile electronic device of the customer-user.

5. The system of claim 4, wherein the digital kiosk is an application operating on the mobile electronic device of the customer-user.

6. The system of claim 3, wherein the digital kiosk comprises an electronic device arranged proximate the plurality of reserved vehicle parking places or the entrance to the retail environment.

7. The system of claim 1, wherein the kiosk is configured to accept payment information from a customer-user, and wherein the analytics engine is configured to cause the customer-user to be charged via the payment information if the analytics engine confirms that the customer-user has not discontinued use of one of the plurality of reserved vehicle parking places by the end of the limited amount of time via data sensed by the at least one parking sensor.

8. The system of claim 7, wherein the payment information comprises a credit card or an earned credit system based on purchases or activities of the customer.

9. The system of claim 1, wherein the analytics engine is configured to determine a path taken by the customer-user in the retail environment via the at least one in-store sensor and the token.

10. The system of claim 9, wherein the analytics engine is configured to suggest at least one alteration to a layout of the retail environment or a location of an item in the retail environment based on at least one of purchase data or aggregated paths of a plurality of customer-users.

11. The system of claim 10, wherein the analytics engine is configured to determine the suggested alteration of layout or location based on items frequently purchased by customer-users of the plurality of reserved vehicle parking places from purchase data from the POS system.

12. The system of claim 10, wherein the analytics engine is configured to determine the suggested alteration of layout or location based on paths frequently taken in the retail environment by customer-users of the plurality of reserved vehicle parking places from data from the at least one in-store sensor.

13. The system of claim 1, wherein the analytics engine is configured to set or adjust the limited amount of time based on customer-user purchase data received from the POS system.

14. The system of claim 1, wherein the at least one parking sensor comprises an optical sensor.

15. The system of claim 1, wherein the token comprises at least one of a radio-frequency identification (RFID) tag or a rechargeable WIFI emitter.

16. The system of claim 15, wherein the kiosk is configured to accept a returned token from a customer-user.

17. A method of managing parking in retail environments comprising:
designating a plurality of reserved vehicle parking places proximate an entrance to a retail environment;
accepting registration of use of one of the plurality of reserved vehicle parking places for a limited amount of time by a customer-user by issuing a token to the customer-user;
displaying a countdown of the limited amount of time remaining on the token;
sensing a presence and a location of the customer-user in the retail environment via the token;
causing the token to stop the countdown when the location of the customer-user is proximate a point-of-sale (POS) system in the retail environment and to resume the countdown when the location of the customer-user is no longer proximate the POS system; and
confirming that the customer-user has discontinued use of one of the plurality of reserved vehicle parking places by the end of the limited amount of time by sensing a presence or an absence of a vehicle associated with the customer-user in the one of the plurality of reserved vehicle parking places.

18. The method of claim 17, further comprising arranging a kiosk proximate the plurality of reserved vehicle parking places, wherein the accepting is done via the kiosk.

19. The method of claim 18, wherein the kiosk comprises an electronic device, and the token comprises a digital token.

20. The method of claim 17, wherein the token comprises at least one of a radio-frequency identification (RFID) tag or a rechargeable WIFI emitter.

21. The method of claim 17, wherein the accepting is done via a mobile electronic device of the customer-user, and wherein the token is a digital token that resides on the mobile electronic device.

22. The method of claim 17, further comprising:
accepting payment information from a customer-user; and
causing the customer-user to be charged via the payment information if the confirming includes sensing a presence of a vehicle associated with the customer-user in the one of the plurality of reserved vehicle parking places after the end of the limited amount of time.

23. The method of claim 22, further comprising earning credits by the customer for use of the plurality of reserved vehicle parking places based on purchases or activities of the customer, wherein the accepting comprises accepting earned credits.

24. The method of claim 17, wherein the sensing comprises determining a path taken by the customer-user in the retail environment.

25. The method of claim 24, further comprising determining at least one possible alteration to a layout of the retail environment or a location of an item in the retail environment based on at least one of the purchase data or aggregated paths of a plurality of customer-users.

26. The method of claim 25, wherein determining at least one possible alteration to a layout of the retail environment or a location of an item in the retail environment is based on items frequently purchased by customer-users of the plurality of reserved vehicle parking places from purchase data from the POS system.

27. The method of claim 17, further comprising setting or adjusting the limited amount of time based on customer-user purchase data from the POS system.

28. The method of claim 17, further comprising accepting a returned token from a customer-user.
